(19) United States
(12) Patent Application Publication
(10) Pub. No.: US 2024/0044162 A1
(43) Pub. Date: Feb. 8, 2024

(54) DEBRIS CONTROL SYSTEMS AND METHODS FOR SWIMMING POOLS AND SPAS

(71) Applicant: ZODIAC POOL SYSTEMS LLC, Carlsbad, CA (US)

(72) Inventors: Darin Eames, Carlsbad, CA (US); Dindo Uy, North Hollywood, CA (US); Mark J. Bauckman, San Marcos, CA (US); Robert Warren Stiles, JR., Carlsbad, CA (US)

(73) Assignee: ZODIAC POOL SYSTEMS LLC, Carlsbad, CA (US)

(21) Appl. No.: 18/231,653

(22) Filed: Aug. 8, 2023

Related U.S. Application Data
(60) Provisional application No. 63/396,026, filed on Aug. 8, 2022.

(51) Int. Cl. E04H 4/12; C02F 1/40; C02F 1/00

(52) U.S. Cl. CPC E04H 4/1272; C02F 1/40; C02F 1/008; C02F 2103/42

(57) ABSTRACT

A debris control system for a swimming pool or spa may receive environmental data for the swimming pool or spa, predict debris conditions in the swimming pool or spa based on the received environmental data, and generate a control response based on the predicted debris conditions. A skimming system for a swimming pool or spa may include an actuated weir door. A method of creating a cleaning effect in a swimming pool or spa includes actuating a weir door.

### REFERENCE TO RELATED APPLICATION

The application claims the benefit of U.S. Provisional Application No. 63/396,026, filed on Aug. 8, 2022, and entitled DEBRIS CONTROL SYSTEMS AND METHODS FOR SWIMMING POOLS AND SPAS, the content of which is hereby incorporated by reference in its entirety.

### FIELD OF THE INVENTION

The invention relates to systems and methods for water-containing vessels such as swimming pools and spas, and more particularly to systems and methods for controlling debris in swimming pools and spas.

### BACKGROUND OF THE INVENTION

Debris may accumulate in a swimming pool or spa for a variety of reasons, such as due to weather events, pool usage, etc. Traditionally, debris removal is performed as a reactionary response, and the removal is typically performed manually by a user (e.g., using a net, etc.) and/or using a passive system such as a skimmer.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a method includes predicting debris conditions in a swimming pool or spa and controlling equipment for the swimming pool or spa based on the predicted debris conditions.

According to various embodiments, a method includes controlling equipment for a swimming pool or spa based on predicted debris conditions.

According to some embodiments, a method includes using environmental information to (i) predict debris conditions for a swimming pool or spa and (ii) control at least one piece of equipment based on the prediction.

According to certain embodiments, a method includes operating an APC based on predicted environmental conditions.

According to some embodiments, a method includes operating an APC based on predicted debris conditions using environmental information.

According to certain embodiments, a swimming pool or spa system includes a debris control system for controlling a piece of equipment for the swimming pool or spa based on predicted debris conditions.

According to various embodiments, a weir door for a swimming pool or spa includes actuation means.

According to certain embodiments, a method includes actuating a weir door to create a cleaning effect in a swimming pool or spa.

According to certain embodiments, a method includes actuating a weir door based on environmental conditions.

According to some embodiments, a method includes actuating a weir door based on predicted debris conditions within a swimming pool or spa.

According to various embodiments, a skimmer includes an actuated weir door that is controlled based on environmental or predicted debris conditions.

A method may include actuating a weir door based on a status of a pump for a swimming pool or spa.

According to certain embodiments, a skimming system for a swimming pool or spa includes an actuated weir door.

According to various embodiments, a debris control system for a swimming pool or spa includes a controller which may (i) receive environmental data for the swimming pool or spa, (ii) predict debris conditions in the swimming pool or spa based on the received environmental data, and (iii) generate a control response based on the predicted debris conditions.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system according to embodiments.

FIG. 2 illustrates skimmer system for the pool system of FIG. 1 according to embodiments.

### DESCRIPTION OF THE INVENTION

Described herein are debris control systems and methods for swimming pools or spas. According to various embodiments, the systems and methods described herein may predict or sense debris conditions (e.g., levels, locations, etc.) for the swimming pools or spas and control one or more pieces of equipment based on the predicted or sensed debris conditions. In some embodiments, the debris conditions are predicted based on environmental information such as but not limited to weather forecasts, wind gauge readings, temperature readings, humidity, etc. The environmental information may be obtained from various sensors, users, and/or other sources as desired. The systems and methods described herein advantageously may control one or more pieces of equipment based on the predicted debris conditions, thereby allowing for quicker and improved debris removal compared to traditional approaches. As examples, an automatic swimming pool cleaner (APC), a pump, a weir door, combinations thereof, and/or other equipment as desired may be controlled based on the predicted or sensed debris conditions. Various other benefits and advantages may be realized with the devices and methods provided herein, and the aforementioned advantages should not be considered limiting.

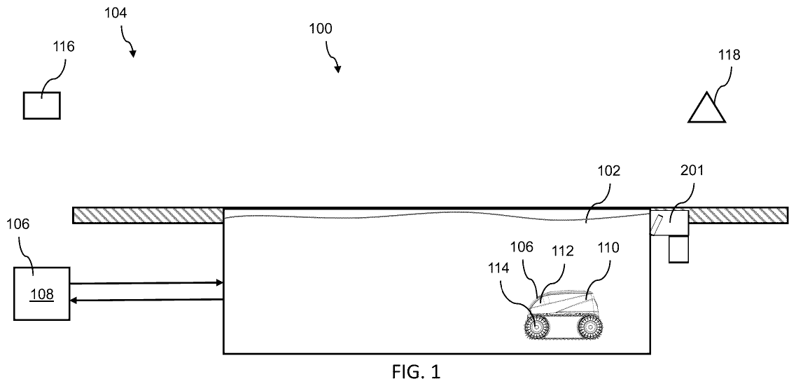

FIG. 1 illustrates an example of a pool system 100 including a swimming pool or spa (hereinafter “pool”) 102 and a debris control system 104. One or more pieces of equipment 106 may be associated with the pool 102, such as but not limited to a pump 108, an APC 110, a skimming system 201, a surface skimmer device movable within the pool 102, a floor cleaning system, and/or other equipment or combinations of equipment 106 as desired.

The APC 110 generally includes a body 112, one or more motive elements 114, and one or more cleaning devices (including but not limited to a scrubber brush). A motor, pump, filter, and various other features may be provided on or within the APC 110 as desired. The APC 10 may be various types of APCs as desired, and the particular APC 110 illustrated should not be considered limiting. Other non-limiting examples of APCs 10 may include those described in U.S. Pat. Nos. 10,316,534, 9,488,154, 8,578,538, and U.S. Patent Publication No. 2014/0303810, all of which are hereby incorporated by reference in their entireties.

In certain embodiments, the debris control system 104 may include one or more environmental sensors 118 for sensing and/or gathering environmental data of the pool environment of the pool system 100. Environmental data may include, but is not limited to, wind data, humidity data, air temperature data, cloud coverage data, direct sunlight exposure data, season or time of year, occupancy data (e.g., presence of a user in the pool 102), combinations thereof, and/or other environmental data as desired. Non-limiting examples of environmental sensors 124 include but are not limited to wind gauges, humidity sensors, temperature sensors, cameras (e.g., for optical sensing), combinations thereof, other water sensors, pool deck sensors, etc. Additionally, or alternatively to environmental sensors 118, the debris control system 104 may receive environmental information from an external source such as a weather forecast from weather forecast provider, weather or other information provided directly from a pool owner, etc.

The debris control system 104 includes a controller 116. The controller 116 may include a computer system and/or one or more processing units and/or one or more memory devices. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data. The memory device may be local to the controller, portable, on a server, or in the cloud, among other locations.

The controller 116 may be provided at various locations relative to the pool 102, including both on or within a pool pad including the pool 102 and/or at a location remote from the pool 102. In certain embodiments, the controller 116 optionally includes an associated user interface, including but not limited to a graphical user interface or a human machine interface, such that the controller 116 may obtain information from a user and/or provide information to the user. Optionally, the interface may include features such as but not limited to a speaker, screen, touchpad, lights, switches, combinations thereof, and/or other human machine interfaces as desired for receiving information from and/or providing information to a user. The user interface and/or human machine interface may be on the controller 116 itself or may be at a location remote from the controller 116, such as on a user device, a dedicated user interface device, an operations control center remote from the pool system 100, combinations thereof, and/or as otherwise desired.

The controller 116 may be communicatively coupled with the environmental sensors 118 (and/or otherwise configured to receive the environmental data) and/or with the one or more pieces of equipment 106 using various wired or wireless communication techniques as desired.

The controller 116 of the debris control system 104 may receive the environmental information from the various aforementioned sources, and based on the received environmental information, the controller 116 may predict debris conditions for the pool 102. Debris conditions may include various predicted characteristics of debris in the pool 102, such as but not limited to, type of debris (e.g., floating debris, sunk debris, etc.), location of debris (e.g., in a deep end of the pool 102, a shallow end of the pool 102, a portion of the pool 102 proximate to a tree, etc.), and an amount or level of debris (e.g., no or minimal levels of debris, light levels of debris, moderate levels of debris, heavy levels of debris, etc.). As non-limiting examples, based on a weather forecast and local pool pad readings of a wind gage, the controller 116 may predict a moderate level of floating debris in the pool 102.

In certain embodiments, based on the predicted debris conditions, the controller 116 may generate a control response for controlling one or more pieces of equipment and/or for generating an alert or notification to a user. As a non-limiting example, the controller 116 may predict a debris level and debris locations within the pool 102 based on wind gauge readings, and based on the predicted debris level and debris locations, the controller 116 may control the APC 110 to initiate cleaning and/or to direct the APC 110 to certain locations in the pool 102. As another non-limiting example, the controller 116 may predict debris levels based on temperature and wind information, and based on the predicted debris levels, the controller 116 may activate the variable speed pump 108 at the highest capacity to draw more water into skimmers of the pool 102. As a further non-limiting example, based on predicted debris conditions, the controller 116 may actuate weir doors (optionally synchronized) to oscillate, thereby creating surface motion to divert the debris to the skimmers.

In some embodiments, the controller 116 may determine a type of control response for the one or more pieces of equipment 106 based on the predicted debris conditions. As non-limiting examples, the controller 116 may selectively actuate and/or prioritize activation of the skimming system 201, the APC 110, a floor cleaning system, the pump, etc. only when needed and/or to perform certain cleaning operations. As a non-limiting example, an APC 110 may be externally powered and/or may have a battery with a longer run time compared to a battery of the skimming system 201, and in such embodiments, the controller 116 may prioritize activation of the APC 110 over the skimming system 201 to preserve the battery of the skimming system 201. As a further non-limiting example, valves for the pump may be actuated such that the pump may be operated in different modes to perform different types of cleaning such as running at a higher speed for a shorter duration or a lower speed for a longer duration. Various other control responses for controlling one or more pieces of equipment 106 may be generated as desired.

Optionally, the controller 116 may receive information in addition to the environmental information and predict the debris conditions based on both the additional information and the environmental information. Additional information may be water quality information, visual data, and/or other data as desired. As a non-limiting example, additional information may be water quality information about water of the pool 102 from one or more water quality sensors 120, and the controller 116 may predict debris conditions based on the environmental information in addition to the water quality information. In such embodiments, the water quality sensors 120 may be optical sensors, temperature sensors, pH sensors, turbidity sensors, combinations thereof, and/or other sensors as desired suitable for detecting one or more characteristics of the water of the pool 102. As another non-limiting example, additional information may be visual data from a camera about the pool 102 and/or location associated with the pool 102, and the controller 116 may predict debris conditions based on the environmental information in addition to visual data. As non-limiting examples, the predicted debris levels may be compared to debris levels as detected in the visual data, and/or the visual data may provide information about occupants of the pool (e.g., humans, pets, etc.) that may further contribute towards debris conditions in the pool 102.

Optionally, in addition to controlling equipment based on predicted debris conditions, the controller 116 may provide information to a user device such as a smartphone or computer (e.g., using an application, wired communication, wireless communication, etc.). The information provided to the user device may be the predicted debris conditions, planned or recommended cleaning or control of equipment based on the predicted debris conditions, past cleaning operations, and/or other alerts or notifications as desired. As a non-limiting example, based on a weather forecast and current debris levels, the debris control system 104 may predict a future increased debris level and plan or recommend controlling the equipment (e.g., skimming system 201, APC 110, floor cleaning system, etc.) in advance to mitigate the accumulation of debris.

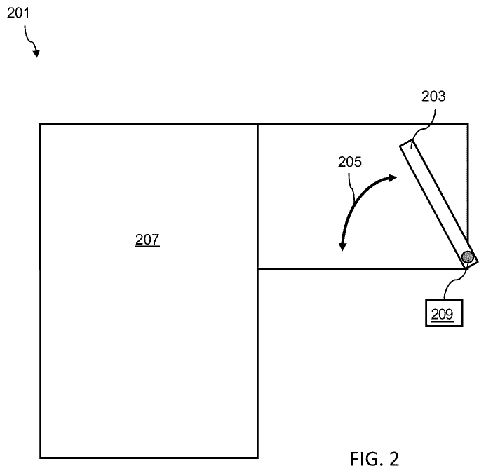

In some embodiments, and referring to FIG. 2, the debris control system 104 may include the skimmer system 201. Referring to FIG. 2, whereas traditional weir doors are passive and rely of a float or flotation to position the door, the skimmer system 201 advantageously may include one or more actuated weir doors 203 providing access to a filter cavity 207. The weir doors 203 may be actuated via various actuations means 209 as desired. Actuation means 209 may be various suitable devices, mechanisms, or features for actively moving the weir doors 203, such as but not limited to various motors, driving mechanisms, linear actuators, combinations thereof, or other actuation means as desired. In some embodiments, the skimmer system 201 and/or the weir door 203 may be powered from an external source, while in other embodiments, an onboard power source, such as but not limited to a battery, may be utilized to power the skimmer system 201 and/or the weir door 203.

Arrow 205 in FIG. 2 represents movement of the weir door 203 when actuated using actuation means. In various embodiments, a position of the weir door 203 may be controlled by the controller 116 and/or as otherwise desired. In various embodiments, the weir door 203 may be actuated to be in various positions based on other equipment and/or for certain pool operations and/or as otherwise desired. As a non-limiting example, the weir door 203 may be actuated such that the weir door 203 is closed when the pump 108 is off and actuated open when the pump 108 is turned on. Such control may create velocity in the water when the weir door 203 is actuated open, which may improve filtration, activation of the skimmer system 201, etc.

In some embodiments, a skimmer system 201 may include a plurality of actuated weir doors 203, and the weir doors 203 optionally may be mechanically, electrically, or otherwise coupled or controlled such that movement of the weir doors 203 is synchronized. In other embodiments, the actuated weir doors 203 need not have synchronized actuation. In some embodiments, the weir door 203 may be controlled or actuated in various modes to create various conditions in the pool 102. As non-limiting examples, the weir door 203 may be controlled by controlling a frequency of opening and closing the weir door 203, a pattern of opening or closing the weir door 203, a duration for which the weir door 203 is actuated, a time at which the weir door is actuated, a particular the weir door 203 of a plurality of weir doors 203 within the pool 102, combinations thereof, and/or as otherwise desired.

While the skimmer system 201 with actuated weir doors 203 is illustrated with the debris control system 104, it need not be in other embodiments. Similarly, the debris control system 104 need not include the skimmer system 201 with the actuated weir door 203.

A non-limiting example case of debris control according to embodiments using the debris control system 104 and/or the skimmer system 201 is discussed in greater detail below. In certain embodiments, and as discussed below, the debris control may rapidly remove surface debris.

In this example, the debris control system 104 may include environmental data such as a weather forecast and local pool pad readings of a wind gage. In certain embodiments, the debris control system 104 may predict a debris control level based on the environmental data and/or the debris control system 104 may confirm the presence of debris and/or level of debris using other sensors such as but not limited to an optical sensor. Optionally, the debris control system 104 may predict floating debris in the pool 102 based on the environmental data and may confirm the prediction based on the optical (or other) sensors. In this example, based on the predicted debris level and floating debris, the debris control system 104 may a variable speed pump and such that the variable speed pump operates with speeds at highest capacity and valves attenuate to increase to draw more water into skimmers. The synchronized weir doors 203 may be controlled to oscillate, thereby creating surface motion to divert the debris to the skimmers. In certain embodiments, the debris control system 104 may predict, detect, and/or determine that a threshold amount of debris has been collected by the skimming system 201 (e.g., when the majority of large debris is collected), and the debris control system 104 may generate a control response to activate a cordless APC 110 to deploy from to complete small debris pickup. In certain embodiments, a notification and/or alert of a time and debris collection is recorded in an application and/or otherwise provided to a user.

The aforementioned examples of debris control and/or actuated weir doors are for illustrative purposes only and should not be considered limiting, and in other embodiments, other types of debris control and/or actuated weir doors may be utilized as desired.

Exemplary concepts or combinations of features of the invention may include:
A. A method comprising predicting debris conditions in a swimming pool or spa and controlling equipment for the swimming pool or spa based on the predicted debris conditions.
B. A method comprising controlling equipment for a swimming pool or spa based on predicted debris conditions.
C. A method comprising using environmental information to (i) predict debris conditions for a swimming pool or spa and (ii) control at least one piece of equipment based on the prediction.
D. A method comprising operating an APC based on predicted environmental conditions.
E. A method comprising operating an APC based on predicted debris conditions using environmental information.
F. A swimming pool or spa comprising a debris control system for controlling a piece of equipment for the swimming pool or spa based on predicted debris conditions.
G. A weir door for a swimming pool or spa, wherein the weir door comprises actuation means.
H. A method comprising actuating a weir door to create a cleaning effect in a swimming pool or spa.
I. The method of any preceding or subsequent statements or combination of statements, further comprising controlling an actuation characteristic of the weir door, and wherein the actuation characteristic comprises at least one of a frequency of opening and closing the weir door, a pattern of opening or closing the weir door, a duration for which the weir door is actuated, or a time at which the weir door is actuated.
J. The method of any preceding or subsequent statements or combination of statements, wherein the weir door is a first weir door of a plurality of weir doors, and wherein the method comprises synchronizing actuation of the plurality of weir doors.
K. The method of any preceding or subsequent statements or combination of statements, wherein the weir door is a first weir door of a plurality of weir doors, and wherein the method comprises independently controlling actuation of each weir door of the plurality of weir doors.
L. A method comprising actuating a weir door based on environmental conditions.
M. A method comprises actuating a weir door based on predicted debris conditions within a swimming pool or spa.
N. A skimmer comprising an actuated weir door that is controlled based on environmental or predicted debris conditions.
O. A method comprising actuating a weir door based on a status of a pump for a swimming pool or spa.
P. A skimming system for a swimming pool or spa, the skimming system comprising an actuated weir door.
Q. The skimming system of any preceding or subsequent statement or combination of statements, further comprising a controller for actuating the weir door, wherein the controller actuates the weir door based on detected environmental conditions from one or more sensors.
R. The skimming system of any preceding or subsequent statement or combination of statements, further comprising a controller for actuating the weir door, wherein the controller actuates the weir door based on predicted environmental conditions for the swimming pool or spa.
S. The skimming system of any preceding or subsequent statement or combination of statements, further comprising at least one environmental sensor, wherein the controller is configured to predict environmental conditions for the swimming pool or spa based on information from the at least one environmental sensor.
T. The skimming system of any preceding or subsequent statement or combination of statements, further comprising a controller for actuating the weir door, wherein the controller actuates the weir door based on a status of a pump of the swimming pool or spa.
U. The skimming system of any preceding or subsequent statement or combination of statements, wherein the weir door is actuated such that the weir door is closed when the pump is off and actuated open when the pump is turned on.
V. The skimming system of any preceding or subsequent statement or combination of statements, wherein the weir door is a first weir door, wherein the skimming system comprises a plurality of weir doors, and wherein actuation of the weir doors is synchronized.
W. A debris control system for a swimming pool or spa comprises a controller configured to (i) receive environmental data for the swimming pool or spa, (ii) predict debris conditions in the swimming pool or spa based on the received environmental data, and (iii) generate a control response based on the predicted debris conditions.
X. The debris control system of any preceding or subsequent statements or combination of statements, wherein the controller is configured to generate a notification to a user as the control response.
Y. The debris control system of any preceding or subsequent statements or combination of statements, wherein controller is configured to control at least one of a skimmer, an automatic swimming pool cleaner, a pump, or a weir door as the control response.
Z. The debris control system of any preceding or subsequent statements or combination of statements, further comprising at least one environmental sensor for measuring at least one environmental condition and providing the measured at least one environmental condition to the controller as environmental data to the controller.
AA. The debris control system of any preceding or subsequent statements or combination of statements, wherein the environmental data comprises a weather forecast.
BB. The debris control system of any preceding or subsequent statements or combination of statements, wherein the controller is configured to recommend a cleaning operation to a user as the control response.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy and for which cleaning of debris is needed or desired.

That which is claimed:

1. A skimming system for a swimming pool or spa, the skimming system comprising an actuated weir door

2. The skimming system of claim 1, further comprising a controller for actuating the weir door, wherein the controller actuates the weir door based on detected environmental conditions from one or more sensors.

3. The skimming system of claim 1, further comprising a controller for actuating the weir door, wherein the controller actuates the weir door based on predicted environmental conditions for the swimming pool or spa.

4. The skimming system of claim 3, further comprising at least one environmental sensor, wherein the controller is configured to predict environmental conditions for the swimming pool or spa based on information from the at least one environmental sensor.

5. The skimming system of claim 1, further comprising a controller for actuating the weir door, wherein the controller actuates the weir door based on a status of a pump of the swimming pool or spa.

6. The skimming system of claim 5, wherein the weir door is actuated such that the weir door is closed when the pump is off and actuated open when the pump is turned on.

7. The skimming system of claim 1, wherein the weir door is a first weir door, wherein the skimming system comprises a plurality of weir doors, and wherein actuation of the weir doors is synchronized.

8. A method of creating a cleaning effect in a swimming pool or spa comprises actuating a weir door.

9. The method of claim 8, wherein actuating the weir door is based on environmental conditions.

10. The method of claim 8, wherein actuating the weir door is based on predicted debris conditions within the swimming pool or spa.

11. The method of claim 8, wherein actuating the weir door is based on a status of a pump for the swimming pool or spa.

12. The method of claim 8, further comprising controlling an actuation characteristic of the weir door, and wherein the actuation characteristic comprises at least one of a frequency of opening and closing the weir door, a pattern of opening or closing the weir door, a duration for which the weir door is actuated, or a time at which the weir door is actuated.

13. The method of claim 8, wherein the weir door is a first weir door of a plurality of weir doors, and wherein the method comprises synchronizing actuation of the plurality of weir doors.

14. The method of claim 8, wherein the weir door is a first weir door of a plurality of weir doors, and wherein the method comprises independently controlling actuation of each weir door of the plurality of weir doors.

15. A debris control system for a swimming pool or spa comprises a controller configured to (i) receive environmental data for the swimming pool or spa, (ii) predict debris conditions in the swimming pool or spa based on the received environmental data, and (iii) generate a control response based on the predicted debris conditions.

16. The debris control system of claim 15, wherein the controller is configured to generate a notification to a user as the control response.

17. The debris control system of claim 15, wherein controller is configured to control at least one of a skimmer, an automatic swimming pool cleaner, a pump, or a weir door as the control response.

18. The debris control system of claim 15, further comprising at least one environmental sensor for measuring at least one environmental condition and providing the measured at least one environmental condition to the controller as environmental data to the controller.

19. The debris control system of claim 15, wherein the environmental data comprises a weather forecast.

20. The debris control system of claim 15, wherein the controller is configured to recommend a cleaning operation to a user as the control response.
